(19) United States
(12) Patent Application Publication
(10) Pub. No.: US 2023/0267819 A1
(43) Pub. Date: Aug. 24, 2023

(54) ADAPTIVE ALERT MESSAGING

(71) Applicant: INTERNATIONAL BUSINESS MACHINES CORPORATION, ARMONK, NY (US)

(72) Inventors: Akash U. Dhoot, Pune (IN); Shailendra Moyal, Pune (IN); Sarbajit K. Rakshit, Kolkata (IN); Venkata Vara Prasad Karri, Visakhapatnam (IN)

(21) Appl. No.: 17/651,819

(22) Filed: Feb. 21, 2022

(51) Int. Cl. G08B 21/18

(52) U.S. Cl. CPC G08B 21/18

(57) ABSTRACT

According to one embodiment, a method, computer system, and computer program product for adaptive alert messaging is provided. The embodiment may include accepting a request for an alert message, wherein the request includes an activity. The embodiment may also include identifying data from the request, including data regarding the activity. The embodiment may further include tracking a status of the activity in light of the data. The embodiment may also include generating one or more alert messages in light of the request, the data, and the status of the activity. The embodiment may further include providing one or more generated alert messages.

### BACKGROUND

The present invention relates generally to the field of computing, and more particularly to user messaging.

User messaging is a User Interface (UI) function where users are provided with messages, alerts, or notifications that signal information to the user. These messages can be provided at predetermined times, at randomized intervals, or in reaction to particular events. In this way, information can be provided when it is most contextually relevant. Reminders might come at times when the user is likely to forget, or in time for the user to take necessary action. Chat notifications might notify users about messages from their friends. Camera and microphone indicators may inform users that their cameras and microphone are in use. As such, User Messaging is an important part of effective, modern UI design.

### SUMMARY

According to one embodiment, a method, computer system, and computer program product for adaptive alert messaging is provided. The embodiment may include accepting a request for an alert message, wherein the request includes an activity. The embodiment may also include identifying data from the request, including data regarding the activity. The embodiment may further include tracking a status of the activity in light of the data. The embodiment may also include generating one or more alert messages in light of the request, the data, and the status of the activity. The embodiment may further include providing one or more generated alert messages.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for adaptive alert messaging according to at least one embodiment.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to user messaging. The following described exemplary embodiments provide a system, method, and program product to, among other things, provide alert messaging to users with information that adapts to the present context regarding a task. Therefore, the present embodiment has the capacity to improve the technical field of user messaging by adapting messages to provide more useful information to users in a more natural context.

As previously described, user messaging is a User Interface (UI) function where users are provided with messages, alerts, or notifications that signal information to the user. These messages can be provided at predetermined times, at randomized intervals, or in reaction to particular events. In this way, information can be provided when it is most contextually relevant. Reminders might come at times when the user is likely to forget, or in time for the user to take necessary action. Chat notifications might notify users about messages from their friends. Camera and microphone indicators may inform users that their cameras and microphone are in use.

Users demand the most useful information available when they receive a message. UI principles also suggest that information will be more helpful to users when it is presented in a more natural manner, appropriate for its context. However, existing user messaging solutions either have limited information available, or are unable to adapt to relevant information to provide the most useful information possible to users. As such, it might be advantageous to track user data regarding an alert message, such as progress through a task, and adapt user messaging to the context of that data.

According to at least one embodiment, a user may receive an alert message regarding a task that adapts to the context of the progress status of that task. Unlike other user messaging systems, the messages here may remind the user specifically to complete the next step required in a given task. The system may break down a task into constituent steps via natural language processing and other known techniques, and track the progress through these steps using a wide variety of methods depending on the specific tasks at hand. Furthermore, if a user requests a reminder for a generic goal at a particular time near the end of the work day, a reminder may remind the user to perform the next step towards that goal at the time requested. The system may also use historical data about the user to select a time based on the user’s habits in checking notifications, or a user’s productivity habits upon receiving notifications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for providing alert messages that are adapted to a particular context or activity status.

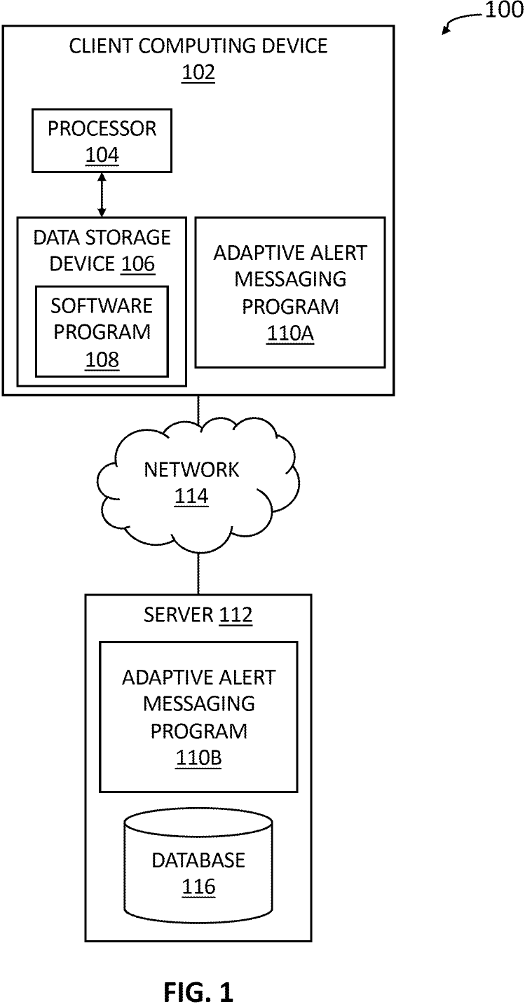

Referring to FIG. 1, an exemplary networked computer environment 100 is depicted, according to at least one embodiment. The networked computer environment 100 may include client computing device 102, and a server 112, interconnected via a communication network 114. According to at least one implementation, the networked computer environment 100 may include a plurality of client computing devices 102 and servers 112 of which only one of each is shown for illustrative brevity. Additionally, in one or more embodiments, the client computing device 102 and server 112 may each individually host an adaptive alert messaging program 110A, 110B. In one or more other embodiments, the adaptive alert messaging program 110A, 110B may be partially hosted on both client computing device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

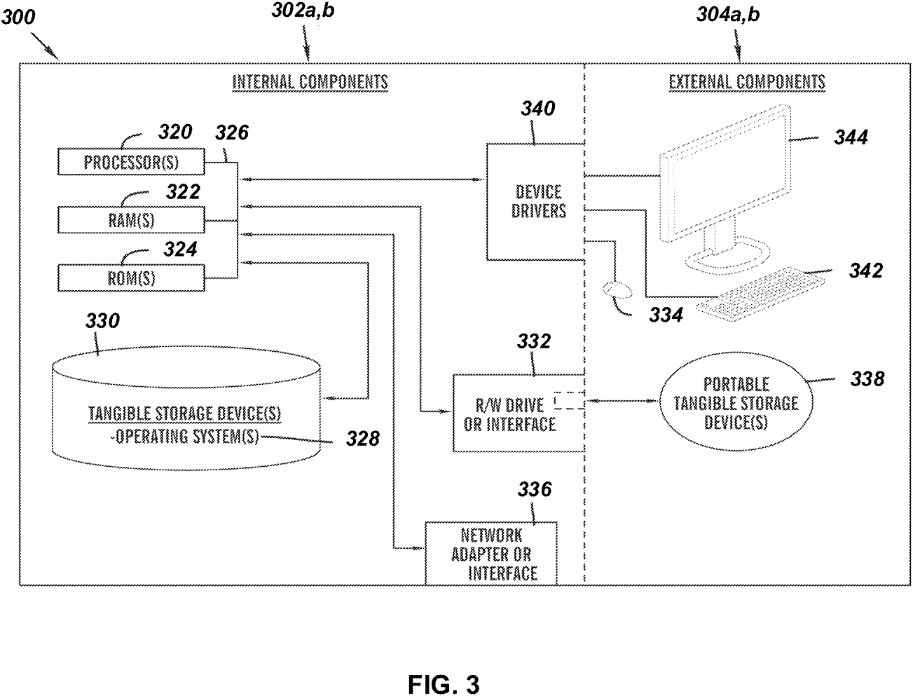

Client computing device 102 may include a processor 104 and a data storage device 106 that is enabled to host and run a software program 108 and an adaptive alert messaging program 110A and communicate with the server 112 via the communication network 114, in accordance with one embodiment of the invention. In one or more other embodiments, client computing device 102 may be, for example, a mobile device, a telephone, a personal digital assistant, a vehicle, a netbook, a laptop computer, a tablet computer, a desktop computer, a smart speaker, a television, or any type of computing device capable of running a program and accessing a network. As previously described, one client computing device 102 is depicted in FIG. 1 for illustrative purposes, however, any number of client computing devices 102 may be utilized. As will be discussed with reference to FIG. 3, the client computing device 102 may include internal components 302a and external components 304a, respectively.

The server computer 112 may be a laptop computer, netbook computer, personal computer (PC), a desktop computer, a smart speaker, a smart home hub, a web server, or any programmable electronic device or any network of programmable electronic devices capable of hosting and running an adaptive alert messaging program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

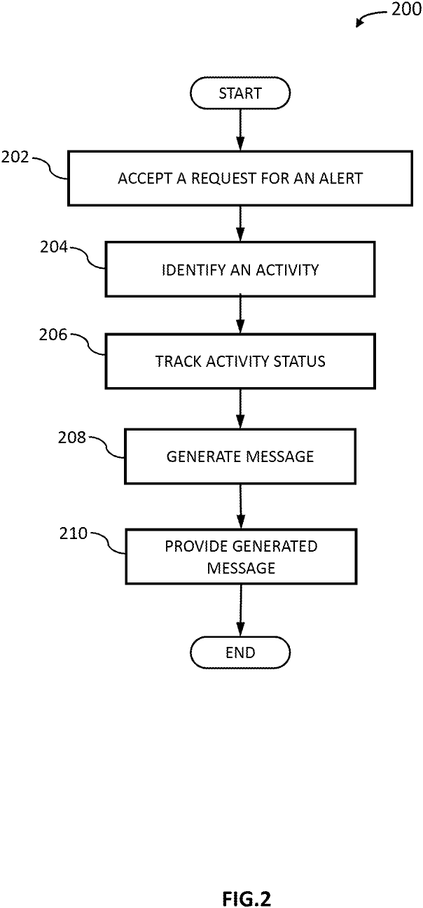

According to the present embodiment, the adaptive alert messaging program 110A, 110B may be capable of adapting a message to a user into a more useful message. In at least one embodiment, the adaptive alert messaging program 110A, 110B may accept a request for an alert. The adaptive alert messaging program 110A, 110B may further process that request. This processing may include parsing the request or breaking down a task in the request into constituent steps. The adaptive alert messaging program 110A, 110B may further track progress through the steps of the activity. In at least one embodiment, the adaptive alert messaging program 110A, 110B may further adapt a message into a more useful message. In at least one embodiment, the adaptive alert messaging program 110A, 110B may provide the adapted message to a user. The method for adaptive alert messaging is explained in further detail below with respect to FIG. 2.

Referring now to FIG. 2, an operational flowchart illustrating a process for adaptive alert messaging 200 is depicted according to at least one embodiment. At 202, the adaptive alert messaging program 110A, 110B accepts a request for an alert message regarding an activity. A user may make a request for an alert message using various methods, such as a touch screen mobile application, voice assistant, or web application. A request may be, for example, a natural language request, a selection of one or more buttons or options, a filled input form, or a calendar entry. Alternatively, the request may be submitted by another source, such as a manager requesting an alert for a user, or an Application Programming Interface (API) that accepts requests from third-party sources such as software program 108. An alert may be, for example, a mobile notification, a desktop notification, an audio reminder by a smart speaker, a message through a chat service, or a combination of the above.

In at least one embodiment, the request may include a time for the alert. The time may be a specific time, such as “5:00 PM today Eastern Time.” The request may specify a time zone, or a time zone may be selected through methods described below at 204. The time may also be a nonspecific time. For example, the request may describe the requested time as “this afternoon.” The time may also be framed as a condition. For example, a user may describe the requested alert time as “when I get home from work.”

In at least one embodiment, the request may include additional information. For example, an input form may include a field for a user’s preferred name. As an alternate example, the request may include a user’s location.

In at least one embodiment, a request may request more than one alert. For example, a request may call for an alert “every day this week.” As an alternate example, a request may call for an alert “whenever it rains.”

Then, at 204, the adaptive alert messaging program 110A, 110B identifies the activity. Identifying the activity may include parsing a natural language request, structuring a request made via button or option-based input, associating the data in the request with other relevant data, or creating new data based on the data of the request or the other relevant data.

In at least one embodiment, parsing the request may include grammatical parsing, using known means, to extract relevant data from a natural language request. Such relevant data may include data regarding an activity or goal for which a notification may be required. Alternatively, an input form may include a field for an activity or goal.

In at least one embodiment, the identifying may include associating the data in the request with other relevant data. For example, if the request includes a time for an alert, the other relevant data may include data regarding the location of a user making the request, which may be used to determine the user’s time zone. Alternatively, if the request includes a time for an alert, the other relevant data may include user data, such as user preferences, which may indicate a preferred time zone. The other relevant data may be stored on the data storage device 106, or in a repository, such as database 116. Alternatively, the adaptive alert messaging program 110A, 110B may seek out or request the other relevant data after the request is made.

In at least one embodiment, the identifying may include creating new data based on the data in the request or the other relevant data. For example, if the user requests an alert when the user arrives at the user’s home, and the other relevant data indicates the user’s current location and home location, the new data may include a projected time when the user may arrive at the user’s home.

In at least one embodiment, the adaptive alert messaging program 110A, 110B may categorize an activity as a multi-step activity, or an activity for which progress can be measured continuously. For example, reading a book is an activity that may be categorized as a multi-step activity or as a continuously measured activity.

In at least one embodiment, an activity may be analyzed further. Analyzing may include breaking a multi-step activity into constituent activity steps or tasks. If reading a book is categorized as a multi-step activity, a step may be completing each page, or, if the book has discrete chapters, completing a chapter. Multi-step activities may further be categorized as ordered step activities or unordered step activities. For example, reading a book may be an ordered step activity, as the pages should be read in a particular order, but reading a magazine may be an unordered step activity, since articles might be read in any order.

Analyzing a continuously measured activity may include determining a method by which to measure progress. If reading a book is categorized as a continuously measured activity, progress may be measured by a decimal or rational number portion of the book that has been read by number of words, lines, or pages completed.

Then, at 206, the adaptive alert messaging program 110A, 110B tracks the status of the activity. For example, if the activity is a multi-step activity, or an activity for which progress can be measured continuously, the adaptive alert messaging program 110A, 110B may track a user or group’s progress through the activity. The adaptive alert messaging program 110A, 110B may track status through various known methods. For example, a user may communicate the completion of a task to a digital assistant, mark a task as complete via checklist software, such as software program 108. Alternatively, a different software program 108 may track the status of an activity automatically. For example, e-reader software may track the current page of a book a user is reading.

Status may also include the name of a user who has completed each task, the time at which each task is completed, a next step that may be completed, or a projection of how long it might take for an activity to be completed in light of current information.

In at least one embodiment, adaptive alert messaging program 110A, 110B may track the status of an activity shared among a group of people. For example, if an activity is managing inventory of a retail store, a group may be the employees of the retail store. Managing inventory may include steps such as counting inventory, comparing inventory counts with expected inventory counts, and moving inventory. Status may therefore include a measure of inventory that has been counted so far, a measure of progress through inventory counts as compared to expected inventory totals, a list of inventory locations and the employees responsible for placing inventory to those locations, or a next task for each employee to complete.

In at least one embodiment, the adaptive alert messaging program 110A may track progress through an activity entirely on a single client computing device 102, which may provide benefits to privacy or performance. For example, a non-internet-connected e-reader may track the page a user is currently reading, or the page a user has most recently read.

Then, at 208, the adaptive alert messaging program 110A, 110B generates an alert message based on the request and activity status. Generating an alert message may include preparing a message, selecting a message from a list of preexisting scripted messages, or modifying a preexisting scripted message. The message may be generated to reflect the next uncompleted task in an ordered multi-step activity, or a selected step from an unordered multi-step activity. For example, if the activity is reading Book A, the generated alert message may be “Read chapter 14!” or “Finish Book A before tomorrow. Chapter 14 is next!” Selecting a step from an unordered multi-step activity may include creating a priority order for uncompleted tasks. For example, tasks in a video game may be prioritized based on a point total each task would earn. Alternatively, the adaptive alert messaging program 110A, 110B may select a step arbitrarily in cases where it is not important which step is selected. For example, generating an alert message for a list of movies to watch may select a movie arbitrarily. Generating an alert message for a continuously measured activity may include adding the progress of the activity to the alert message. For example, if the activity is reading Book B, the generated alert message may be “Finish Book B. You are currently 73% of the way done!”

In at least one embodiment, an alert message may be generated in light of other relevant data. For example, a generated alert message may include a user’s name. Alternatively, the intended time for a notification may be adapted in light of other relevant data or status information.

In at least one embodiment, adapting an alert message may include adapting based on other status information. For example, if a team of employees is engaged in an inventory activity, and Bob has not completed as many tasks as other employees on the team, the adapted alert message may be “Your team has two hours to finish inventory. You guys are 68% done. Maybe Bob should count the swivel chairs.”

In at least one embodiment, the adaptive alert messaging program 110A, 110B may generate more than one alert message corresponding to one request. For example, if a user requests a reminder to read at least ten pages of a 189-page novel every day until she is finished, the generated alerts may remind the user to read through page 10, 24, 37, 49, 77, 92, 114, 120, 136, 155, 181, and 189.

Then, at 210, the adaptive alert messaging program 110A, 110B transmits the generated alert message. The generated alert message may be provided to a device, a user, a group of users, a manager, or an API. APIs may include an operating system notification API, a browser notification API, a voice assistant API, a web service such as IFTTT ® (IFTTT and all IFTTT-based trademarks and logos are trademarks or registered trademarks of IFTTT Inc. and/or its affiliates). Providing a message to a device may include, in addition to messaging through APIs, messaging via chat service; messaging via social media service; messaging via telephone call; messaging via E-Mail; messaging to a software program 108; or messaging to adaptive alert messaging program 110A, 110B. In addition to the foregoing, messaging to a user, group of users, or manager may include messaging via physical mail, messenger service, or any other form of communication.

In at least one embodiment, the alert message may be provided at the requested time, or at a time determined through other means described. One or more alert messages may be provided at one or more times.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302a,b and external components 304a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the adaptive alert messaging program 110A in the client computing device 102 and the adaptive alert messaging program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the adaptive alert messaging program 110A, 110B, can be stored on one or more of the respective portable computer-readable tangible storage devices 338, read via the respective R/W drive or interface 332, and loaded into the respective hard drive 330.

Each set of internal components 302a,b also includes network adapters or interfaces 336 such as a TCP/IP adapter cards, wireless Wi-Fi interface cards, or 3G or 4G wireless interface cards or other wired or wireless communication links. The software program 108 and the adaptive alert messaging program 110A in the client computing device 102 and the adaptive alert messaging program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the adaptive alert messaging program 110A in the client computing device 102 and the adaptive alert messaging program 110B in the server 112 are loaded into the respective hard drive 330. The network may comprise copper wires, optical fibers, wireless transmission, routers, firewalls, switches, gateway computers and/or edge servers.

Each of the sets of external components 304a,b can include a computer display monitor 344, a keyboard 342, and a computer mouse 334. External components 304a,b can also include touch screens, virtual keyboards, touch pads, pointing devices, and other human interface devices. Each of the sets of internal components 302a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

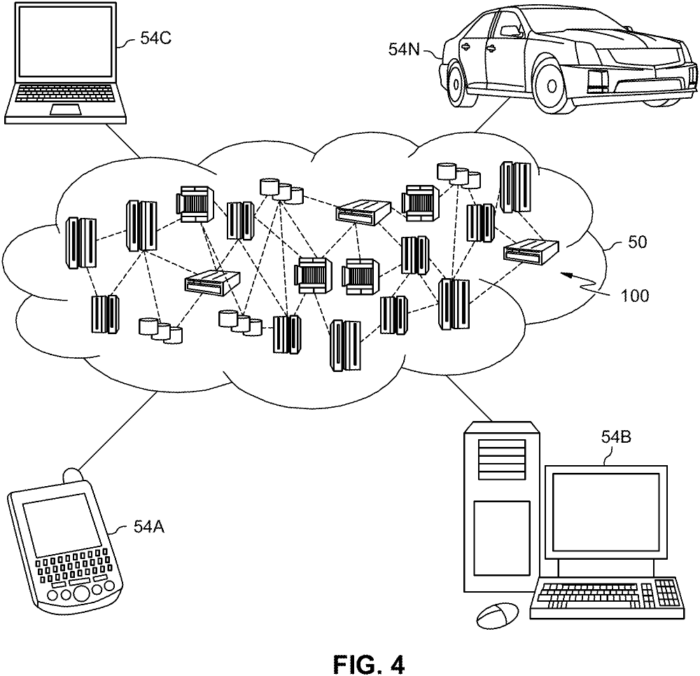

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54AN shown in FIG. 4 are intended to be illustrative only and that computing nodes 100 and cloud computing environment 50 can communicate with any type of computerized device over any type of network and/or network addressable connection (e.g., using a web browser).

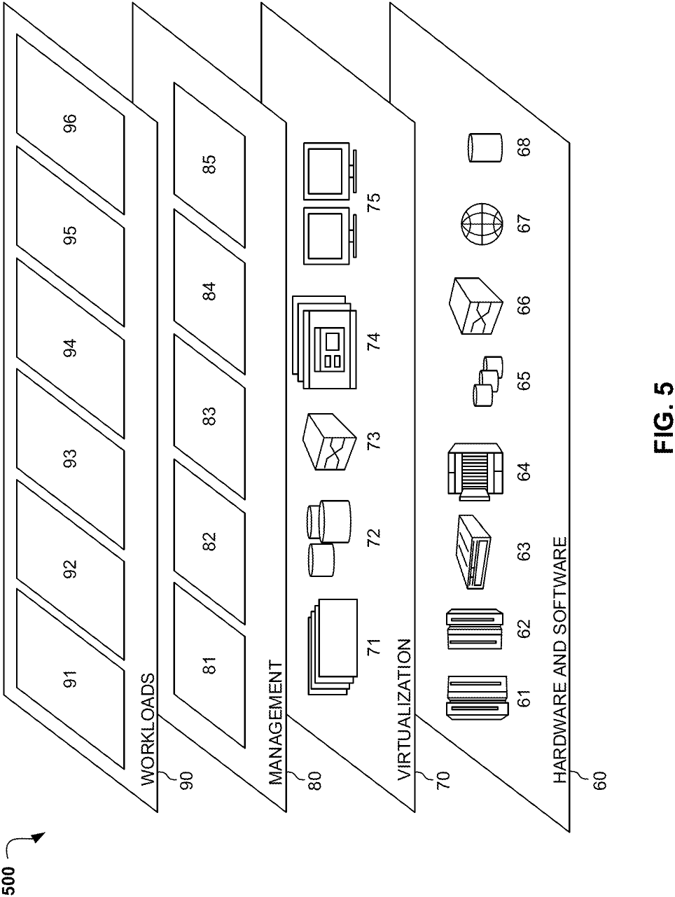

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adaptive alert messaging 96. Adaptive alert messaging 96 may relate to providing alert messages that are adapted to a particular context or activity status.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
accepting a request for an alert message, wherein the request includes an activity;
identifying data from the request, including data regarding the activity;
tracking a status of the activity in light of the data;
generating one or more alert messages in light of the request, the data, and the status of the activity; and
providing one or more generated alert messages.

2. The method of claim 1, wherein identifying data from the request further comprises: identifying two or more steps of the activity.

3. The method of claim 2, wherein tracking the status of the activity further comprises:
tracking the status based on a completion of each activity step within the two or more steps.

4. The method of claim 1, wherein tracking the status of the activity further comprises:
tracking the status based on a progress through the activity where the activity is an activity for which progress is measured continuously.

5. The method of claim 1, wherein the activity is performed by two or more users.

6. The method of claim 5, wherein the one or more generated alert messages are provided to the two or more users.

7. The method of claim 1, wherein the method is conducted on a local area network.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
accepting a request for an alert message, wherein the request includes an activity;
identifying data from the request, including data regarding the activity;
tracking a status of the activity in light of the data;
generating one or more alert messages in light of the request, the data, and the status of the activity; and
providing one or more generated alert messages.

9. The computer system of claim 8, wherein identifying data from the request further comprises:
identifying two or more steps of the activity.

10. The computer system of claim 9, wherein tracking the status of the activity further comprises:
tracking the status based on a completion of each activity step within the two or more steps.

11. The computer system of claim 8, wherein tracking the status of the activity further comprises:
tracking the status based on a progress through the activity where the activity is an activity for which progress is measured continuously.

12. The computer system of claim 8, wherein the activity is performed by two or more users.

13. The computer system of claim 12, wherein the one or more generated alert messages are provided to the two or more users.

14. The computer system of claim 8, wherein the method is conducted on a local area network.

15. A computer program product, the computer program product comprising:
one or more computer-readable tangible storage medium and program instructions stored on at least one of the one or more tangible storage medium, the program instructions executable by a processor capable of performing a method, the method comprising:
accepting a request for an alert message, wherein the request includes an activity;
identifying data from the request, including data regarding the activity;
tracking a status of the activity in light of the data;
generating one or more alert messages in light of the request, the data, and the status of the activity; and
providing one or more generated alert messages.

16. The computer program product of claim 15, wherein identifying data from the request further comprises:
identifying two or more steps of the activity.

17. The computer program product of claim 16, wherein tracking the status of the activity further comprises:
tracking the status based on a completion of each activity step within the two or more steps.

18. The computer program product of claim 15, wherein tracking the status of the activity further comprises:
tracking the status based on a progress through the activity where the activity is an activity for which progress is measured continuously.

19. The computer program product of claim 15, wherein the activity is performed by two or more users.

20. The computer program product of claim 19, wherein the one or more generated alert messages are provided to the two or more users.
